(19) United States
(12) Patent Application Publication
(10) Pub. No.: US 2013/0179313 A1
(43) Pub. Date: Jul. 11, 2013

(54) System and Method for Converting and Presenting Financial Information

(71) Applicants: Paritosh Chandra Basu, Mumbai (IN); Sanjay Chauhan, Mumbai (IN); Kiran Menon, Mumbai (IN); Gyanesh Sharma, Mumbai (IN)

(72) Inventors: Paritosh Chandra Basu, Mumbai (IN); Sanjay Chauhan, Mumbai (IN); Kiran Menon, Mumbai (IN); Gyanesh Sharma, Mumbai (IN)

(73) Assignee: ESSAR INVESTMENTS LIMITED, Mumbai (IN)

(21) Appl. No.: 13/820,266

(22) PCT Filed: Dec. 27, 2011
(86) PCT No.: PCT/IN11/00896

§ 371 Date: Mar. 1, 2013

(30) Foreign Application Priority Data
Dec. 29, 2010 (IN) 3564/MUM/2010

(51) Int. Cl. G06Q 40/00

(52) U.S. Cl. CPC G06Q 40/10
USPC 705/30

(57) ABSTRACT

A system for converting and presenting financial information from at least one accounting and reporting standard to another accounting and reporting standard comprising an access control means to verify credentials of a user logging in to get access of the system, an input source for feeding in transaction details and calculating account head-wise trial balance; an extraction layer for fetching the head-wise trial balance from the input sources; a financial data management module (FDM) for validating and mapping account head-wise trial balance received from the input sources; an ETI block for fetching and populating account head-wise trial balance and populating the same into a database through an interface table; the interface table for converting head-wise trial balance and fetching other transaction details together known as financial information, for conversion purpose.

### FIELD OF THE INVENTION

The present invention relates to a system and method for converting and presenting financial information and more particularly, the invention provides an automated system and method for converting financial information and statements for reporting from one accounting and reporting standard to a different accounting and reporting standard.

### BACKGROUND

With the globalization and advancement in communication technologies, the world has become one integrated village. Geographical barriers can no longer be a constraint for enterprises to setup their offices in different countries rather globalization necessitates them to have units operating in different countries.

A multinational business conglomerate can have various business divisions in the form of legal entities engaging in different activities and can have offices in different countries spread across different continents. A company may have hundreds of stand-alone entities as its direct and indirect subsidiaries, associates and ventures spread over several countries in different continents. All these entities have to maintain accounts and report financial results complying with respective local and/or international accounting standards. Local frameworks and accounting standards include without limitation local Generally Accepted Accounting Principles (GAAP) such as US GAAP, Japanese GAAP etc. while international accounting standard includes without limitation International Financial Reporting Standard (IFRS). In fact, in most cases the local accounting standard like local GAAP needs to be converted to an international accounting standard like IFRS, and vice versa depending upon reporting requirements. IFRS is increasingly being adopted by countries across the globe to facilitate reporting of financial statements in one language across the globe yet at the same time there are countries like India, wherein consolidated financial statements are to be reported by corporates in Indian GAAP and hence there is a need for this system. Accordingly, the accountants of those countries and entities, who prepare accounts and report financial results under the respective local GAAP, convert the accounts to IFRS or any other country specific GAAP like US GAAP, Japanese GAAP etc. for consolidation and reporting under the GAAP applicable to its holding company to enable the same to be consolidated.

Different business entities under one multinational group or divisions of the same entity may conduct large number of transactions involving huge values amongst themselves across geographies besides crisscrossing each other in terms of investments, lending arrangements, etc. Therefore, there is also a need for elimination of such intra-group, inter-group transactions, receivables and profits earned inter-se at the time of consolidation of accounts at step levels after bringing them at par in terms of compliance and the GAAP in which the financial statements are being reported.

Such consolidation of data and its conversions from various local GAAP to IFRS and vice versa are presently being done at financial statement level with long drawn manual steps and processes. As an example, Microsoft™ Excel™ facility is used for both such conversions and consolidation. Such a manual system is fraught with a large number of risk exposures in terms of quality, speed, data reliability safety and security, besides multiplicity of non-standard systems and processes being followed by accountants across entities under a group. In addition, it is difficult to ensure that all provisions of the concerned GAAP are being complied with in full and in conformity with one set of interpretations and accounting policies stemming from that.

Thus, a system is needed that automates such a conversion from one accounting standard to the other and vice versa and minimizes required manual work in the process. Further, it is required that the complex and intricate issues in differences between an international accounting standard like IFRS or the GAAP of any other country in which the financial statements are being reported and local accounting standard of various countries be resolved and human effort based working processes be replaced by an automated IT enabled system.

This is essential as most of those countries may continue with local accounting standard for a while even after adopting any international accounting standards like IFRS for meeting various other requirements, e.g. assessment of income under local Direct Taxes legislation. For example, in the past and recent years, many countries in the North and South America, Europe, Asia and Africa encourage corporate houses or make it compulsory to adopt IFRS. Yet at the same time in many of those countries consolidated accounts are to be prepared and reported in IFRS, for which conversion of standalone entity level accounts under IFRS is the first and foremost requirement.

Typically, in the prior art there are systems and methods to consolidate, present, manage and report financial information. Further, with the advent of information technology, there are systems and methods available for automatically performing accounting procedure.

U.S. Pat. No. 6,058,375 discloses an accounting processor and method for automated management control system. The invention discloses an automatic accounting processor and method for automatically performing an accounting procedure for transaction data on a real time basis through menu selection and input or a data communication network on a computer system, by standardizing, formulating and compounding a management control business of an enterprise. The automatic accounting processor includes a transmitter/receiver, a display/input unit, a storage unit, a processing unit, and an output unit. The automatic accounting processor and method allows an automatic accounting procedure without an accounting knowledge. In addition, an accounting procedure and a balancing operation procedure are performed on a real time basis, by automatically controlling errors generated during the accounting procedure, thereby realizing an effective management control.

However, the invention is a transaction processing system, which can perform some automatic accounting procedures for writing books of accounts and performing management control by automatically controlling errors generated during accounting procedure. The invention does not teach any method and system to convert the financial information from one accounting and reporting standard to other.

U.S. Pat. No. 7,565,311 discloses a conversion engine and financial reporting system using the conversion engine. The invention is a computerized management system. The system includes a routine for accessing journal entries stored in a memory and an automated journal entry generating routine for generating journal entries for a first set-of-books and for a second set-of-books based on the accessed journal entries. The journal entries for the first set-of-books are in accordance with a first reporting standard and the journal entries for the second set-of-books are in accordance with a second, different reporting standard.

However, the scope of the invention is limited to routines for accessing journal entries stored in a memory with inclusion and exclusion rules only and automated journal entry generating routine. Further, the system works on the inputs received from only application software and it does not teach its working using any middleware or from any customized format. The system has an inbuilt limitation of not dealing with rules framed by various regulatory and tax authorities. Further, the system is limited to conversion of commercial lending, deposit, treasury, trade finance, accounts payable, accounts receivable and inventory only and the same cannot be customized based on user's requirement. The system has a limitation to work with single workflow and accesses only journal entries and through the engine reverses and/creates new journal entries for conversion.

US Publication No. 20050222945 discloses systems and methods for managing and reporting financial information. The method and system facilitate the management of financial information. Such methods and systems may receive transaction data, store the transaction data as a line item in a day ledger, receive a request for a report, the request indicating a financial figure, such as an average daily balance, to be generated over a specified time interval, and generate, substantially in real-time or during run-time per the request, a report with the financial figure over the specified time interval using data from the day ledger.

However, the scope of the system and method is limited to generation of MIS from general ledger and does not disclose the system and method to convert and present the financial information from one accounting and reporting standard to another.

To overcome the above-mentioned disadvantages and several others, the proposed invention is disclosed herewith an automated system and method for converting and presenting financial information and statements for reporting from one accounting and reporting standard to a different accounting and a reporting standard.

### SUMMARY OF THE INVENTION

The present invention overcomes the drawbacks discussed earlier above and provides a system for converting of the Trial Balance (TB) prepared in a local accounting standard of any country to IFRS and vice versa. It further facilitates the process of preparation of periodical accounts, after taking the TB and other financial data from the IT system, in which the books are written under local GAAP. It also facilitates the process of incorporating into it accounting entries required for adjustments and/or corrections to the financial data under the local GAAP, at standalone entity level and thereafter consolidation of them as stated above with the help of some other IT system, e.g. Hyperion™ system. The IT enabled conversion system provides facilities for conversion from the local GAAP to IFRS related measurements and adjustments as well as business logic requirements of compliance of various standards under IFRS, into one platform. It therefore also acts as the ‘technical guide’ and ‘facilitation tool’ for accurate accounting of regular and complex business transactions in compliance with the IFRS, yet it does not require correcting/rewriting the accounts as per primary books of accounts prepared in compliance with local GAAP.

The conversion system is also capable of converting each line of the TB of any legal entity, prepared under local accounting GAAP for example Indian GAAP into another Trial Balance in compliance with an international accounting standard such as the IFRS or vice versa. The conversion system further facilitates/generates several reports as desired by a user for complying with requirements for preparation of Notes to Accounts and for further analysis including for sensitivity and reporting with the prescribed degree of transparency as well as elements for reconciliation of certain financial results as per the local GAAP and IFRS or vice versa.

The present invention relates to a system and method to convert the trial balances of different entities maintained using different system of writing books of accounts under different accounting GAAP at different geographical regions into a desired accounting and reporting standard. Such conversion is done by recording certain journal vouchers by using data calculated by the system, using data as well as business logic and conversion rules and fed financial information. These are typically known as accounting entries in the form of journal entries. Further, the income and expenditure details maintained in the form of journal entries are segregated under separate heads, typically known as ledger account. After segregation, calculations and aggregations are performed and the respective balance under each ledger account is collectively called as trial balance.

The accompanying drawings, which are incorporated in and constitute a part of the specification, illustrate various features of the present invention and together with the general description given above and the detailed description provided below, serve to explain the principles of the invention.

### OBJECT OF THE INVENTION

Besides overcoming the disadvantages of the above mentioned prior arts, a system and method to convert the financial information with many other facilities and enabling systems is disclosed herein. The objectives of the invention are as follows:
1. An object of the invention is providing a robust system and method to convert the financial data into the accounting and reporting standard of choice.
2. Another object of the invention is to provide a controlled system to effectively facilitate the process of consolidating the data from various standalone entities, and convert them in a desired accounting and reporting format in order to comply with the statutory requirements.
3. Yet another object of the invention is to provide a system, which system is intelligent enough to measure and calculate values required to pass conversion journal entries for the applicable adjustments with a given set of business rules and GAAP compliance principles.
4. Another object of the invention is to provide a system, which system reduces human interventions to such an extent whereby after receiving a set of instruction, the system on its own accomplishes most of the tasks and provides desired results based on business rules designed in the system.
5. Again another object of the invention is to provide a system, which system eases the conversion process of data from one reporting standard to another without any hassle.
6. Yet another object of the invention is to provide a system, which system reduces the chance of human and mathematical error and aid due diligence process by making detailed data available over past accounting periods.
7. Another object of the invention is to provide a system, which system can aid in regulatory and accounting GAAP compliance requirements in matters of Deferred tax.
8. An object of the invention is to provide a system, which can provide flexibility to switch the types of enterprises resource planning system such as without limitation SAP™, Tally™ etc. as used by any business entity for feeding data without affecting the outcome.
9. Another object of the invention is to provide a system, which system has a build-in process for strict access control for administrators, business users, approver/reviewers and viewers based on their work profile in respect of legal entity and user specific roles.
10. Yet another object of the invention is to provide an effective security system, which system eliminates local storage of data in laptop or desktop computers of business users, reviewers, business users and possibility of security and integrity leakages by ensuring central storage of data and server side.
11. Another object of this invention is to generate report with the help of already generated data and store within the system without taking additional primary data input, in other words generate outputs from self learnt data.

### BRIEF DESCRIPTION OF THE INVENTION

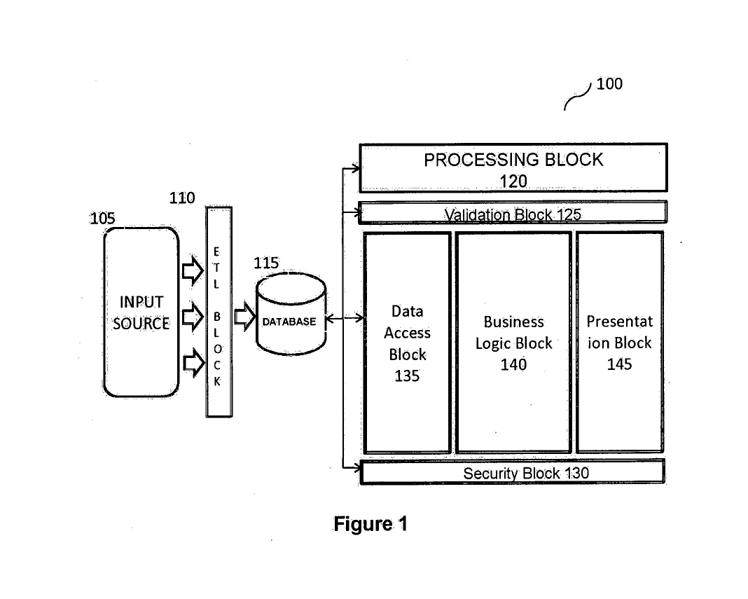

FIG. 1 depicts an architectural overview in accordance with an exemplary embodiment of the present invention.

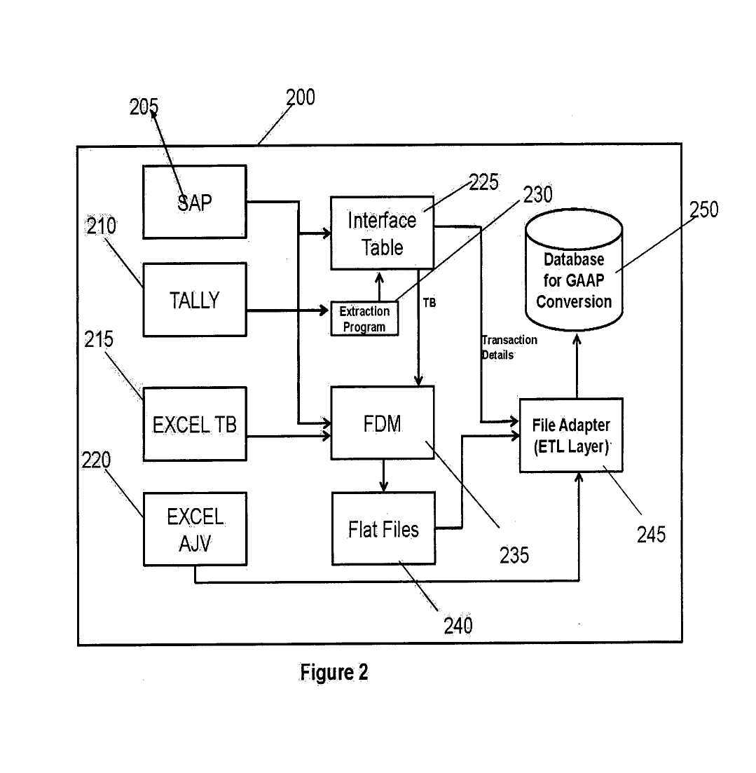

FIG. 2 illustrates a block diagram explaining the data movement from input sources of an exemplary embodiment of the present invention.

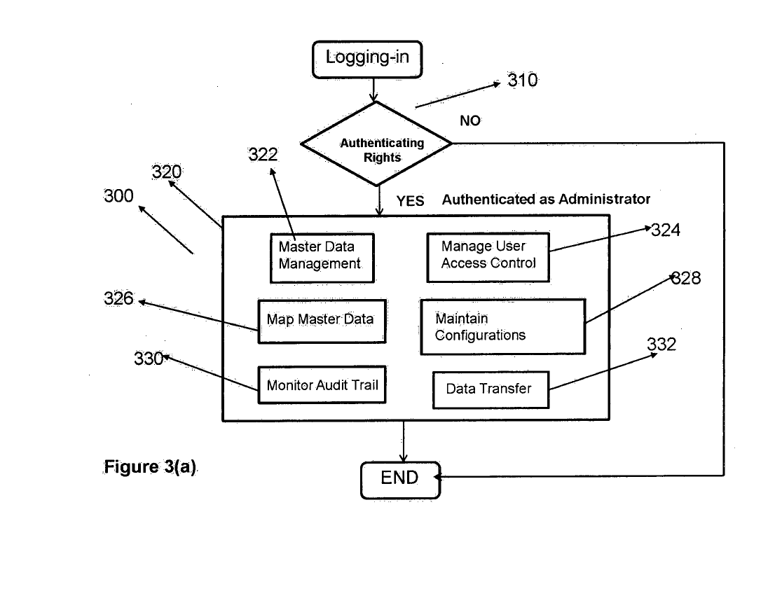

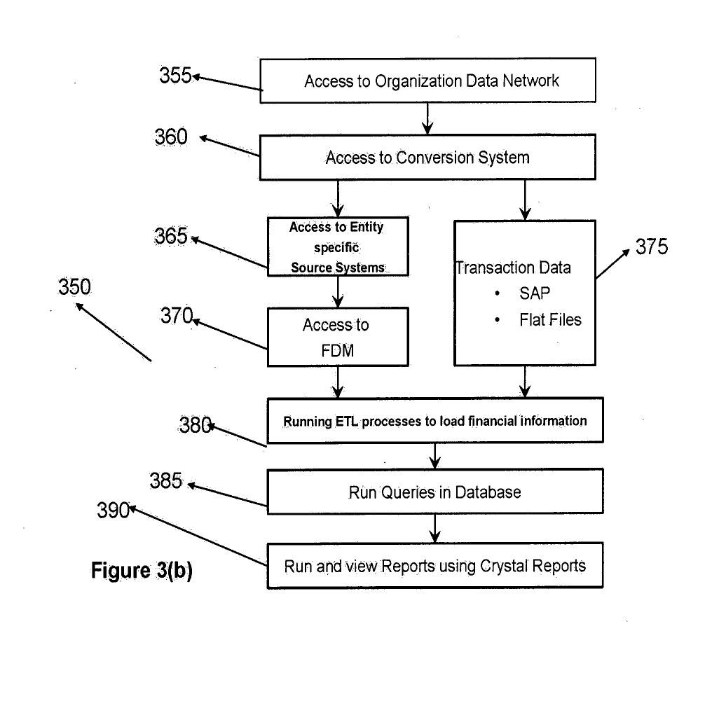

FIGS. 3(a) & (b) depicts a process flow of administrator and user access control of the present invention.

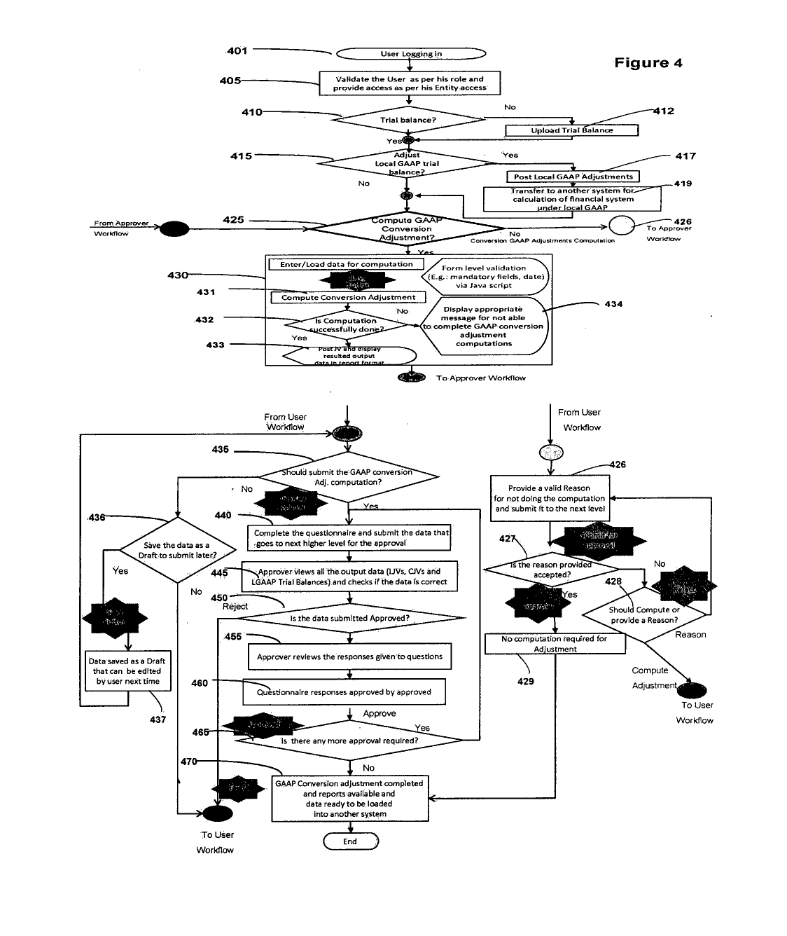

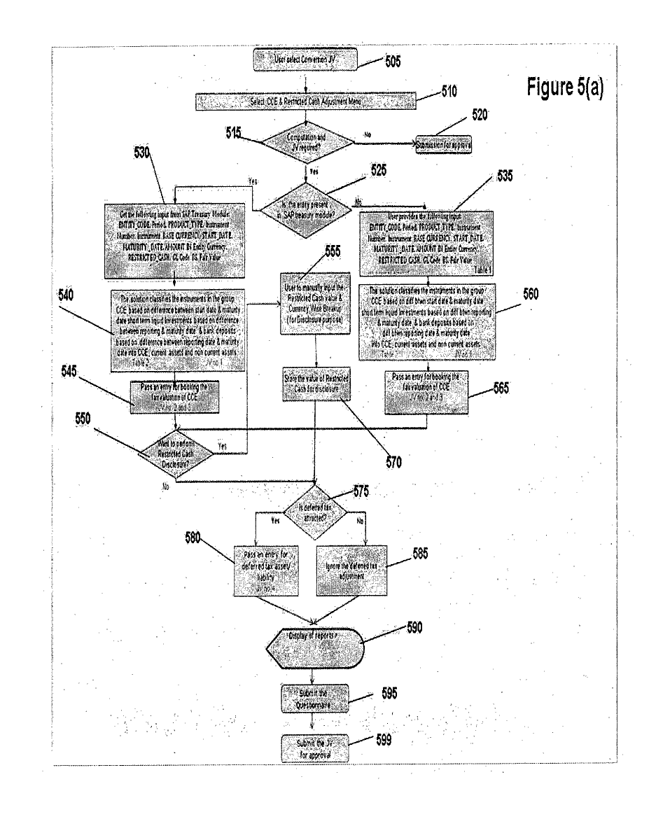

FIG. 4 illustrates a complete process flow of conversion of financial information from one accounting and reporting standard to another of an exemplary embodiment of the present invention.

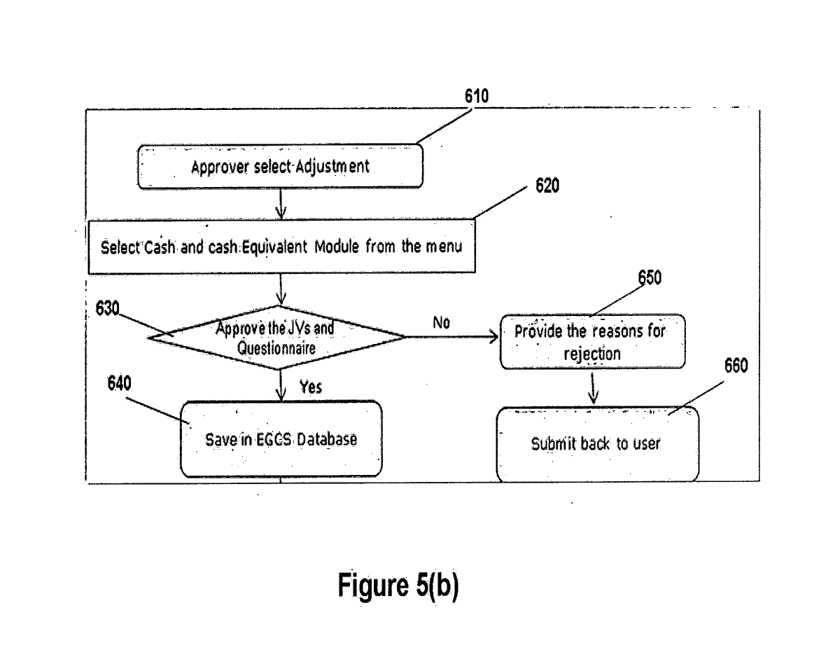

FIGS. 5(a) & (b) depicts an illustration of Cash and Cash Equivalent (CCE) module of an embodiment of the conversion system as explained herein.

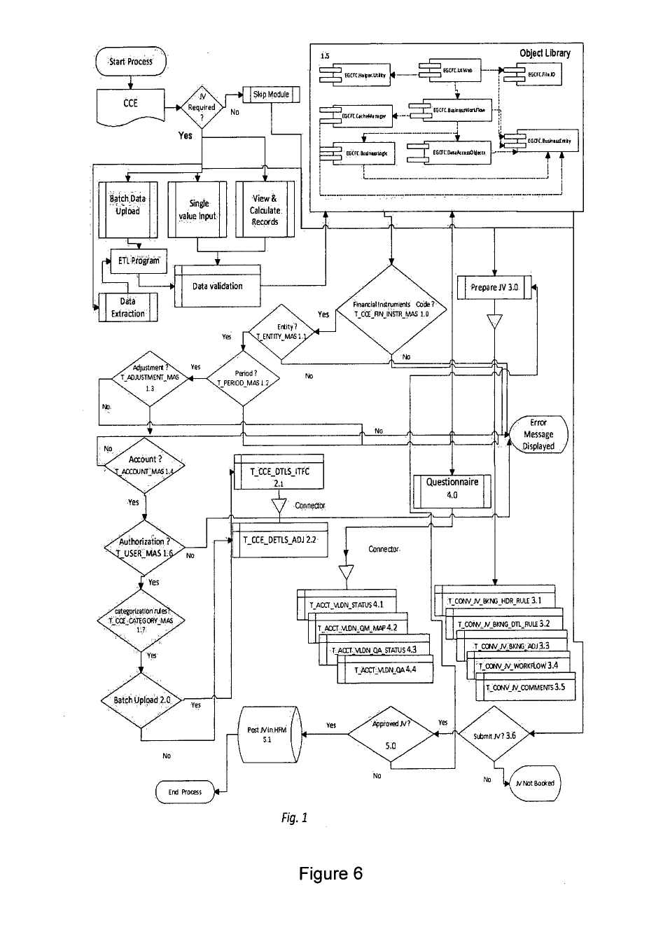

FIG. 6 is a flow chart for the CCE Module in Conversion system.

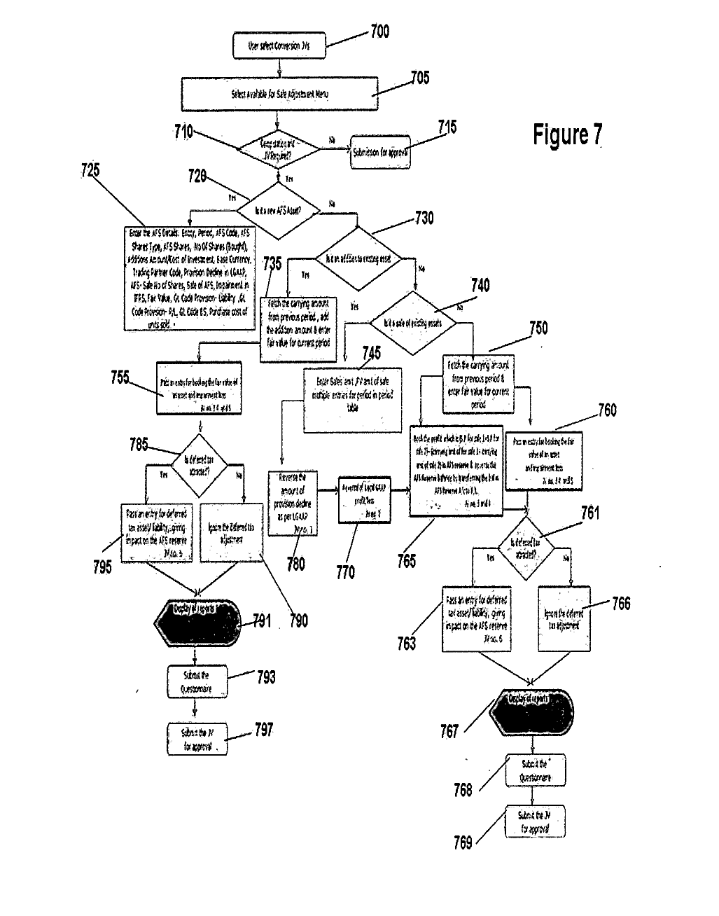

FIG. 7 depicts an illustration of investments available for sale (AFS) module of an embodiment of the conversion system as explained herein.

### DETAILED DESCRIPTION OF THE INVENTION

FIG. 1 depicts an architectural overview in accordance with an exemplary embodiment of the present invention. A system 100 to convert and present financial information is disclosed herewith. The system 100 includes various input sources 105 for storing accounting details of its day to day transactions, an extract, transform and load (ETL) block 110 capable of extracting, transforming and loading information from various input sources 105, a database 115 capable of storing financial information and a processing block 120 capable of processing the financial information.

Typically, in any business entity, the accounting details of its day-to-day transactions are maintained using the input sources 105. The input sources 105 are typically various systems of writing books of accounts, some of which are also known as enterprise resource planning (ERP). A few examples of such enterprise resource planning systems are without limitation SAP™, Tally™, Oracle™, Sage™ etc. The books of accounts can also be written using various other systems such as Microsoft™ Excel™ and the like. In a preferred embodiment, a user using the input source 105 can maintain the books of accounts in the form of accounting including journal entries such as, without limitation day to day transactions pertaining to capital & operating expenditure, revenue earnings, fund raising, repayments of outstanding debts, bills payable and receivables, prepaid, direct and indirect expenses, direct and indirect income, closing and opening stocks of raw materials and finished goods, details of debtor and creditor, bad debt, fixed and liquid assets including cash, short and long term liability including loan, and the like in primary books of accounts. Each accounting entry including journal entry is grouped based on various account heads called as ledgers. After grouping accounting entries and journal entries under various ledger heads, the input source 105 calculates account head-wise list collectively called as trial balance (TB). The head-wise TB is either populated directly into a financial data management (FDM) module such as, without limitation Hyperion™, or any other customized financial data management module or else it will be converted into a format compliant to FDM through interface table and subsequently populated into the FDM. The financial data management module is capable of validating the trial balance based on country specific regulatory compliance and best financial practices. The validated trial balance from the financial data management module is pulled through ETL block 110 and pushed into an interface table of the database 115. The input source 105 also populates other transaction related details such as, without limitation inter-company transactions, loans, deposits and the like, directly into the interface table with the help of pre-codified extraction programs. The interface table acts as a bridge between input source 105 and the database 115. Each interface table is designed and created considering various conversion requirements from one accounting and reporting standard to other and vice versa. The trial balance and other transactions details entered into the interface table are then parsed and segregated in line with business operation based on various predefined business rules. The parsed and segregated trial balance and other transaction details (hereinafter “financial information”) is stored into the database 115. The financial information once uploaded into the database 115 cannot be altered or modified thereby securing the financial information and ensuring to provide accurate conversion as output based on input financial information. At any stage, if the alteration or modification of the financial information is unavoidable, the user has to alter the trial balance and the transaction details at input source level by passing adjustment journal entries. Depending on the nature and enormity of the alteration, the process of extracting and uploading financial information has to be redone. A user after providing valid reasons for alterations and after getting approval from the approving authorities can alter the financial information manually in the interface table of the database 115 by passing adjustment journal entries under the local GAAP. This method includes various access control mechanisms, which are subsequently explained in following drawings/diagrams.

The ETL block 110 is capable of importing financial information from all systems of writing books of accounts using common information templates and data retrieval processes. The ETL block 110 is responsible for overall management of importing financial information from input sources 105 and populating it into the database 115.

The ETL block 110 communicates with the database 115 that stores, without limitation, the financial information related to all the masters, mapping tables, various configuration tables, adjustment specific data, final output table, various audit trails, interface tables, data access and security tables and the like. The database 115 can be a relational database management system, wherein the data is stored and manipulated collectively with various queries in a query language. In an embodiment, the database 115 is an Oracle™ standalone database.

The financial information stored in the database 115 is accessed by the processing block 120. The processing block 120 through a data access block 135, a business logic block 140, a validation block 125, a presentation block 145 and a security block 130 processes the financial information.

The data access block 135 contains all the logics to fetch financial information stored in the database 115 with the help of a number of object and helper classes that facilitates database connectivity and there is no database connectivity beyond the data access block 135. As referred earlier, after uploading the financial information into the database 115, the user can alter/modify the financial information using data access block 135. The data access block 135 after due verification of user's credentials through security block 130 allows the user to alter/modify the financial information using pre-codified standard process including without limitation editing, modifying, updating, uploading and the like. The logic of communication with the database 115 are localized at the data access block 135 thereby restricting all the communications pertaining to fetching, altering, modifying the financial information between the database 115 and the processing block 120 through data access block 135 only.

The validation block 125 operating universally on the system 100 includes the validation logic on the financial information. The validation block 125 operates on the financial information fetched by the data access block 135 from the database 115. The validation block 125 validates various parameters of the financial information such as without limitation data entry validation, financial information mapping, access related validation and the like.

In an embodiment at the time of fetching and entering the financial information, it will validate whether the financial information complies with basic rules such as, without limitation transaction date of financial information cannot be in future, the transaction date should be in specific format, mapping of the financial information i.e. the incoming financial information should not contain more than one entity detail and one transaction detail for one period at a time, financial data access related validation i.e. users cannot see financial information pertaining to entities where they don't have access and the like.

The validated financial information from using data access block 135 is passed into the business logic block 140. The business logic block 140 contains various business rules and logics and calculation methods for converting financial information from one accounting and reporting standard to another. The business logic block 140 converts the financial information in different accounting and reporting standards based on user's requirement. The business logic block 140 includes specific measurement and calculation logic for revised valuation of economic effects of the collective values of transactions under each line item of the financial information under local accounting and reporting standard for generating conversion journal entries in compliance with another accounting and reporting standard.

The processing block 120, which communicates universally with the system 100, in its communication with the business logic block 140 processes the financial information and performs various types of conversions from one accounting and reporting standard to another and vice versa to produce converted financial information.

The processing block 120 further measures the revised economic values of a number of sets of business transactions in compliance with one international accounting standard say IFRS, which were earlier measured and accounted for under different local accounting standard like Indian GAAP, US GAAP, Canadian GAAP and the like using:
1. Pre-identified points of differences between local accounting standard like Indian GAAP vis-à-vis international accounting standard like IFRS;
2. Certain predefined and pre-programmed set of rules,
3. Certain static and dynamic meta data and master data,
4. Actual summarized values of transactions captured in the Trial Balances and
5. Individual transactions as imported in the database and converted as detailed above.

The processing block 120 then generates conversion journal entries (CJVs) for each such revised value, either for the differential amount or for the full value based on the requirements of the set of rules. It then also calculates and generates conversion journal entries for deferred taxation in compliance with the international accounting standards under IFRS using for example, the Balance Sheet approach.

The processing block 120 prepares a summary of converted financial information such as conversion journal entries and generates a separate derived trial balance, which indicates the value differentials between the local accounting standard and the international accounting standard. If asked for by the users through a menu button, it converts the derived trial balance into a report indicating impact of GAAP conversion on Profit after Tax and Net Worth. Finally, the processing block 120 consolidates the local trial balance under the local accounting standard, after accepting the conversion journal entries and the derived trial balance and prepares the converted trial balance information, fully complied with the international accounting standard.

Further, the processing block 120 interacts with the presentation block 145 to present output data calculated/computed by the business logic block 140 based on user's queries. The presentation block 145 for presenting the output data deals with the user interface of the system 100. The user interface includes without limitation web based screens, controls, workflow guidance and navigation.

The system 100 also provides security features and access control. It includes a security block 130 that caters to security at various levels, which include without limitation:
Organization controlled security,
Application level security;
Task based Security, and
Operating system level security.

It can be seen that multiple tiered level of security is provided by the security block 130, which enables an organization to define the access rights for a user at an application, task, or object level so that a user accesses only that data for which the user is authorized.

The converted financial information along with adjustment journal entries and conversion journal entries from the system can be transported to another computing system to prepare financial statements, comprising of Income Statement, Balance Sheet, Statement of Other Comprehensive Income, Statement of Changes in Equity, Cash flow and several analytical Tables for preparation of Notes to Accounts, etc. The system produces a number of detailed different disclosure reports in order to meet both regulatory reporting obligations as well as operational reporting. These reports can also be stored in file forms like MS™ Excel™, Adobe™ Acrobat™ and the like.

The system 100 can also work in a reverse mode. As an illustration, if any local trial balance as submitted to the system 100 has been prepared in compliance with an international accounting standard, i.e., say under IFRS and there is a need to convert it to a local accounting standard like Indian GAAP for consolidating with other companies of a business group complying with consolidation standards of the Indian GAAP, the system is also capable of providing modules for reverse measurement of economic values of the required collective transaction values under a line item in the local trial balance, in the instant case local trial balance being under IFRS, and accordingly will generate a conversion journal entry in compliance with the Indian GAAP.

FIG. 2 illustrates a block diagram explaining the data movement from various input sources by way of an illustration of an exemplary embodiment of the present invention. The process of data movement can be customized based on the various types of input sources employed by any conglomerate. The data movement process in a system 200 includes various input sources such as SAP™ 205, Tally™ 210, and preformatted excel table of trial balance 215 and preformatted excel table of adjustments 220. In an embodiment as illustrated herein, the data movement is designed in accordance to the type of input source from where the financial information is to be fetched.

In an embodiment, a user (not shown) with the help of various input sources enters the transaction details in a specific module. The modules of a system 200 includes without limitation Administration and Overhead Capital Work in Progress, Available For Sale, Bill Discounting (Debtors), Bills Payable (Acceptances), Borrowings, Cash And Cash Equivalent, Construction, Current/Non Current Reclassification, Decapitalization of Forex, Deferred Tax, Derivatives, Employee Benefits, Financial Guarantee, Forward Cover/Contract, Held For Sale, Intangible Assets, Inventory, Investment Property, Leases, Loans, Manual Journal Vouchers, Outsourced Costs, Personnel Costs, Preference Shares-Liability, Property Plant And Equipment, Provisions, Sales Tax, Scrap Sales, etc.

The input source by way of an illustration, without limitation, can be SAP™ 205, Tally™ 210, pre-formatted excel tables for trial balance 215 and the like. If the input source is assumed to be SAP™ 205, the financial information can be fetched either through interface table 225 or through the financial data management module 235 and uploaded into the database 250 through the file adapter (ETL) layer 245. The interface table 225 acts as a bridge between the input source and the file adapter (ETL Layer) 245. The interface table 225 can be designed and created using pre-codified logics to accommodate financial information for conversion. The trial balance in the financial information can be uploaded to database 250 through financial data management module 235, whereas other transaction details of the financial information can be uploaded directly to the database 250 without passing through the financial data management module 235. Similarly, if the input source is Tally™ 210 the financial information is fetched through an extraction program 230 and pushed into the interface table 225 and subsequently fetched through the file adapter (ETL) layer 245 and fed into the database 250. The extraction program 230 is a pre-codified program, which can extract the financial information using pre-codified logic from the input source Tally™ 210.

The system 200 can also operate using pre-formatted excel tables 215 and 220. The system 200 provides an option to the user to populate the preformatted excel table with trial balance (TB) 215 into the financial data management module 235. The financial information present in the financial data management module 235 is parsed and segregated into line items based on the business codes. These segregated line items are called flat files 240. These flat files 240 are subsequently pushed into the database 250 using file adapter (ETL) layer 245. In a similar scenario, the trial balance is extracted from SAP™ 205, Tally™ 210 or from any preformatted excel table of trial balance 215 and can be corrected/modified by incorporating adjustment journal vouchers listed in preformatted excel table of adjustments 220 and the same can be uploaded in the database 250 through the file adapter (ETL) layer 245.

The database 250 of the system 200 is a standalone relational database. The data stored in the database 250 includes financial information i.e. processed trial balance, details of various financial transactions required for GAAP conversion and inter-company transactions as input details, converted financial information called as output details, mapping table, various audit trails, user access security details, interface tables and the like. All the queries executed by the user pertaining to the conversion of financial information from one accounting and reporting standard to another and vice versa are saved in the database 250. This relational database 250 is capable of allowing system 200 to reuse the financial information for multiple times or for multiple purposes once entered into the system 200 by the user.

As an illustration without limitation, a property, plant and equipment module (PPE module) of any business entity is discussed herewith. The business entity uses SAP™ or manually uploaded data in pre-formatted excel template as an input source. A user of the input source enters the details pertaining to a new asset such as but not limited to asset procurement date, procurement cost, and the like in the month of purchase. The transaction details of new asset are fetched into the database through the ETL block. The database has already pre-defined master data called as asset group, method of depreciation and the like. This asset group includes attributes of fixed assets such as useful life, residual value percentage and the like. While entering the details of a new asset in the system, the user defines the relational mapping between the transaction details of new asset and the master data of the asset group. Post relational mapping, the system uses the mapping to calculate depreciation for all the periods scanning across the asset life based on transaction data such as but not limited to asset procurement date, procurement cost, residual value and the like entered by the user in the month of purchase. These calculations are very useful at the time of conversion of financial information from one accounting and reporting standard and vice versa.

FIG. 3(a) depicts a process flow of a user access control system 300 of an embodiment of the present invention. As shown in the flow process, a user logs into the system 300. After logging in the user is required to enter user credentials, which can be any username, password, encrypted data log-in, or any access control means. The system 300 after receiving the user's credentials verifies the same and authenticates the type of user 310. In the present embodiment, without limitation the user types are administrator, user, viewer and approver. The user types can be added or deleted depending upon the need of the organization.

In the illustration discussed herein without limitation, the system 300 verifies the user as an administrator. Post identification, the administrator can get access to all the controls and related data stored and managed into the system 300. The administrator thereby enjoys bundle of rights, which a normal user cannot. The administrator is entitled to undertake all the administrative tasks 320 such as but not limited to management of master data 322, user access control 324, mapping master data 326, maintaining configurations 328, monitoring audit trail 330 and transforming output data 332 of conversion into another system such as Hyperion™ for preparation of financial statement under local GAAP and IFRS. The financial statement under local GAAP and IFRS is prepared based on business rules as applicable for reporting principles.

FIG. 3(b) illustrates a process flow of user's access into the system 350 of another embodiment of the present invention. As an illustration as discussed herein, a user has to get an access to the organization network 355. Every organization can implement various methods to give access to its users such as login-password, encryption-decryption key, retina scan, finger impression and the like. This is the first tier of security proposed in the system 350 as disclosed herein. After getting access to organization's network, the user has to re-verify its credentials by second sign in to get access to the conversion system 360. This is a second tier security system proposed in the system 350 as disclosed herein. After getting access to the conversion system 360 the user can either upload the financial information or else can generate the report directly by running a specific query into the conversion system 360.

By way of an illustration, without limitation, if the user wishes to upload the financial information, after getting access to the conversion system 360 it will access the entity specific source system 365 for which he is authorized to upload the financial information. After getting access to the entity specific source system 365, the user can access the financial data management module 370 for bringing in the trial balances as well as the financial information stored in the form of transaction data 375 fetched/uploaded from various input sources such as SAP™, Tally™ or pre-formatted excel table by running the ETL process 380.

The system 350 based on the input transaction data 375 and user's requirement converts the financial information from one accounting and reporting standard to another. The user after conversion runs various queries in the database 385 to extract the converted financial information. After receiving the converted financial information, the user can view the reports of conversion of financial information using crystal reports 390.

FIG. 4 illustrates a process flow of conversion of financial information from one accounting and reporting standard to another of an exemplary embodiment of the present invention.

In step 401, a user logs into the conversion system. Before entering into the conversion system, the user has to verify his credentials and get access to the organizational network. The verification of the user's credentials at the time of entering the organizational network acts as the first tier access control. After getting access to the organizational network, each user is provided with a username and password typically required for verifying the user's credentials including approved user rights. This acts as the second tier access control.

In step 405, the system validates the user as per his role and provides him the access to a specific entity. Each user in the system is assigned an entity specific task for calculating and uploading the financial information, pass conversion journal entries and take out reports. Typically, the types of user may vary from user, approver, administrator and the like. The access to the system is also limited to the types of entities authorized under user's credential account. The user after verification is mapped to one or more entities of which he can upload the trial balance.

In step 410, after verifying and providing access to the user, the system requires the user to upload the trial balance 412. It is a conditional stage, wherein if the trial balance is not uploaded in the system the user will have to upload the trial balance for generation of those entries which are required for reversal of certain effects of local GAAP before the conversion is effected. If the trial balance is already uploaded the user can move to the next step.

In step 415, the system can deal with further adjustments of financial data under the local GAAP if it requires any adjustment entries before conversions. It is again a conditional stage, wherein if the adjustment entries are not required to be posted the system will move to the next step. However, if the adjustment entries are required to be posted, it will allow the user to post the suitable adjustment entries 417 and the same will be transferred to another system such as Hyperion™ for computation of financial statements under the local GAAP 419.

In step 425, the system will prompt for calculation of GAAP conversion adjustments in the approved or validated trial balance (verified trial balance) forwarded from the financial data management module. This being a conditional step, if the user does not wish to compute conversion GAAP adjustment, the user has to provide a valid reason for the same 426. The user can submit the reason for non computation for approval to the approver. The approver can verify the reason and either accept the reason 427 or reject the reason with the explanation 428 and send it back to the user for computation of GAAP conversion adjustment. If the reason provided by the user is approved by the approver, the system will load the transaction detail into another system such as Hyperion™ for computation of financial statements of the entity.

In step 430, if the user has to compute conversion GAAP adjustment the system will provide facility to load the data for computation 431. At 432, if the computation is successful, it will post journal vouchers and display the resulted output data into report format 433 or else will display appropriate message for not able to complete GAAP conversion adjustment computations 434. The computation of GAAP conversion journal entries requires mapping of entity to conversion module and master table for adjustments. In entity adjustment mapping, every entity of the organization is mapped to the list of adjustments to be performed. Further, all the adjustments to be done for the selected entity are displayed on the screen. In the master adjustment table, the adjustment master stores all the list of adjustments to be carried out along with their sequence and their dependability on each other.

In step 435, the conversion journal entry after computation is forwarded for approval before finalizing it into the form of report. The approver has the right to verify all the data and approve or reject the data based on validity of the verified trial balance and computed values for which the conversion journal entry is passed. In any event, if the user would not like to submit the conversion journal entry for approval, it can have an option to save 436 it in draft format for later use 437.

In step 440, the computed conversion adjustments are submitted to approver for approval.

In step 445, the approver views all the data such as without limitation verified trial balance, conversion journal entries, and the like.

In step 450, the approver after validating the verified trial balance, conversion journal entries may approve the same, subject to verification of certain standard questions prompted by the system to the approvers. If the journal entries are not approved, it will be sent back to the user for modification.

In step 455, the approver after validating the data will also review the responses given by the users to the questions posted by the system at the time of conversion.

In step 460, the approver reviews the responses to the questions posted by the system. These questions are a set of basic queries, which are prompted to user while computing the adjustment entries so as to make sure that the user's computation is guided towards logical flow and complies with the entire requirements for conversion.

In step 465, the system will check if any other approval is required. If yes, it will shift the control to step 440 i.e. submission of data for approval, if no, then the system will move to the next step.

In step 470, if no approval is required, the system will general report of the conversion adjustment entries and will load the data into another system such as Hyperion™ for computation of financial statements under the local GAAP.

FIGS. 5(a) & (b) depicts an illustration of cash and cash equivalent (CCE) module of an embodiment of the conversion system as explained herein. The CCE module as discussed herein classifies cash and bank balances as reported in the trial balance under local GAAP, say under Indian GAAP, into three different groups required under International Financial Reporting Standard (IFRS) i.e. cash and cash equivalents, current term deposits and non-current term deposits.

Typically, cash equivalents are assets that can be readily converted into cash, such as without limitation money market holdings, short-term government bonds, treasury bills, marketable securities and commercial papers. Cash equivalents are distinguished from other investments through their short-term existence, i.e. they can be matured within 3 months of issuance whereas short-term investments have 12 months or less as their maturity period and any investment having more than 12 months maturity period are called as long-term investments. If the data is maintained electronically in any ERP then all data related to cash and cash equivalent as explained above is available in treasury module of its accounting ERP and the breakdown of such financial data can be transferred from the treasury module itself. Further, in case of any lien present on cash equivalent in the treasury module of any ERP, it will directly pull as restricted cash based on international reporting standards such as US GAAP, IFRS etc.

The following are the steps followed for the cash and cash equivalent module:

Step 1: If the entity maintains all data related to cash equivalent as explained above in treasury module maintained in the accounting ERP, get the breakdown of such financial data from the module.

Step 2: If the entity does not maintain the same in Treasury Module maintained in the accounting ERP, manually provide the start date and the maturity date of the instruments and accordingly the system will reclassify into the respective classification to be reported based on the original maturity and the maturity from the reporting date.

Step 3: Pulling the disclosure of restricted cash as per International standards viz. USGAAP, IFRS etc. according to the lien type to which the cash equivalents are subject to and thus becomes restricted items of cash equivalent if the data is maintained by the entity on the Treasury Module.

Step 4: If the data as in 3 above is not in Treasury Module, the user will have to identify manually the amount to be disclosed as restricted cash and load into the system.

FIG. 5(a) illustrates an example of conversion of financial information from one reporting or accounting standard to another into Cash and Cash Equivalent (CCE) Module.

Illustration:

The following example would make the reader understand designed workflow in a better manner. The example has been solved with the help of the various steps undertaken by the solution while executing the program of CCE Module.

TABLE 1

| | Instrument | | | Amount | | | Previous Period |
|---|---|---|---|---|---|---|---|
| Instrument | Base | | Maturity | in Entity | Restricted | Fair | differential fair |
| Number | Currency | Start date | Date | Currency | Cash | Value | Value Booked |
| Xyz 11111 | USD | 1 Mar. 2010 | 30 May. 2010 | 2,000,000 | 1,500,000 | 2,000,000 | 100,000 |
| Xyz 11112 | INR | 2 Mar. 2010 | 5 Sep. 2010 | 180,000 | 80,000 | 160,000 | 50,000 |
| Xyz 11113 | GBP | 3 Mar. 2010 | 4 Aug. 2011 | 700,000 | 70,000 | 850,000 | (10,000) |
| Xyz 11114 | INR | 4 Mar. 2010 | 7 Oct. 2010 | 600,000 | — | 600,000 | — |

Assume the reporting date is Mar. 31, 2010. Tax rate is assumed to be 30%.

Based on the above data, the system will calculate the initial maturity period for classification into current and non-current and the maturity time left from the reporting date till the end of the instrument period.

TABLE 2

| | | | | Maturity from | | |
|---|---|---|---|---|---|---|
| | Instrument | No of days | Amount | Mar. 31, 2010 | | Previous period |
| Instrument | Base | (Start Date − | in Entity | till the | Fair Value | differential fair |
| Number | Currency | Maturity date) | Currency | Maturity date | Adjustment | Value Booked |
| Xyz 11111 | USD | 60 | 2,000,000 | Less than | — | 100,000 |
| | | | | 1 year | | |
| Xyz 11112 | INR | 158 | 180,000 | Less than | (20,000) | 50,000 |
| | | | | 1 year | | |
| Xyz 11113 | GBP | 491 | 700,000 | Greater | 150,000 | (10,000) |
| | | | | than 1 | | |
| | | | | year | | |
| Xyz 11114 | INR | 190 | 600,000 | Less than | — | — |
| | | | | 1 year | | |

A Conversion Journal entry for booking of deferred tax on fair valuation gain/loss will be passed for INR 10,000(INR 140,000−130,000)@30%.

A user selects a conversion journal voucher 505 from the CCE and restricted cash adjustment module 510. At this stage, the user is prompted with a query of computing journal voucher 515. If in the selected accounting period, there exists no requirements for passing conversion journal voucher then the module can be skipped and can directly move to approver for approval 520.

If the conversion journal voucher is required, the module will prompt to check if the entity exists in the SAP™ treasury module 525. If the entity is present in the SAP™ treasury module, the details such as entity code, period, product type, instrument number, base currency, start date, maturity date, and the like are fetched from the SAP™ treasury module 530. If the entity is not present in the SAP™ treasury module, the user will have to manually feed in all the data 535.

After fetching the data from the treasury module or manual entry of the data by the user, the system will automatically classify the instruments into the group CCE based on difference between the start and maturity date, short term liquid investments based on difference between reporting and maturity date and bank deposits based on difference between reporting and maturity date into the CCE module, current asset and non-current asset 540,560. In both the cases wherein if SAP™ treasury module contains the data or user manually enters the data, after classification an entry for booking fair valuation is passed into the CCE module 545, 565.

The entry passed for booking fair valuation is passed into the CCE module and the user will be prompted with a query to perform restricted cash disclosure 550. If the restricted cash disclosure is to be done, the user will manually enter the restricted cash value and currency-wise breakup 555 and will show the restricted value of cash disclosure 570.

If the restricted cash disclosure is not to be performed, the user is prompted with another query of deferred tax attraction i.e. whether this transaction would attract any deferred tax 575. If the transaction attracts deferred tax a separate entry for the same will be passed 580. If the transaction does not attract the deferred tax 585, the conversion journal entry is displayed 590 along with the questionnaire. The responses to the questionnaire 595 as well as the conversion journal voucher are forwarded to the approver 599.

FIG. 5(b) illustrates an approval process undertaken by the approver 610. After entering the system, the approver will select CCE module 620. After selecting the CCE module, the approver will be prompted with the journal voucher and responses to the questionnaire forwarded by the user 630.

If the approver decides to reject the journal voucher 630 and the responses to the questionnaire, the approver has to provide a valid reason 650 and the same will be sent' back to user for correction 660. If the approver approves the journal voucher the same is saved into the database for further processing 640.

Journal Entries Passed for CCE for the Above Example

1. Reclassification from Cash and Cash Equivalent

| Account | | | | |
|---|---|---|---|---|
| Code | Account Description | Status | Dr/Cr | Amount |
| 26094911 | TERM DEPOSIT | Current | Dr | 780,000 |
| 26094912 | TERM DEPOSIT | Non- | Dr | 700,000 |
| | | current | | |
| 26020220 | SBI-HZ-CA-10272750107- | Current | Cr | 1,480,000 |
| | MAIN | | | |

2. Fair Value on Mutual Funds

| Account | | | | |
|---|---|---|---|---|
| Code | Account Description | Status | Dr/Cr | Amount |
| 21011801 | Current Investments - | Current | Dr | 150,000 |
| | Non - Trade units in mutual | | | |
| | funds - Quoted | | | |
| 21011802 | Current Investments - Non - | Current | Cr | 20,000 |
| | Trade units in mutual funds - | | | |
| | Unquoted | | | |
| 38010014 | Income from Mutual Funds | | Cr | 130,000 |

3. Reversal of Previous Year Fair Value on Mutual Funds

| Account | | | | |
|---|---|---|---|---|
| Code | Account Description | Status | Dr/Cr | Amount |
| 38010014 | Income from Mutual Funds | | Dr | 140,000 |
| 21011802 | Current Investments - | Current | Dr | 10,000 |
| | Non - Trade units in | | | |
| | mutual funds - Unquoted | | | |
| 21011801 | Current Investments- | Current | Cr | 150,000 |
| | Non - Trade units in | | | |
| | mutual funds - Quoted | | | |

4. Deferred Tax Entry

| Account | | | | |
|---|---|---|---|---|
| Code | Account Description | Status | Dr/Cr | Amount |
| 22000001 | Deferred Tax Asset | Non Current | Dr. | 3,000 |
| 68000002 | Deferred Tax Charge/Credit | | Cr. | 3,000 |

JV No. 1 has been passed for reclassification of the deposits maturing after 90 days as current or non-current based on maturity period of less than 1 year or more than 1 year from the reporting date.

JV No. 2 has been passed for accounting the fair valuation gain/loss on the mutual fund units when their cost is compared with the fair value at the end of each reporting period.

JV No. 3 has been passed for reversing the impact of the fair valuation gain/loss of the previous financial years.

JV No. 4 has been passed for booking of deferred tax on fair valuation gain/loss.

FIG. 6 is a flow chart for the CCE Module in Conversion system. The boxes 1.0 to 1.7 show master tables, which contain the validation attributes. 1.0T_CCE_FIN_INSTR_MAS is the master table for storing all the types of financial instruments, which are classified as CCE. 1.1 T_ENTITY_MAS is the master table for storing all entities attributes data. 1.2 T_PERIOD_MAS is the master table for storing all periods into the system and used by all modules—where a period denotes a month. This table contains periods between JAN-1900 to DEC-2150. 1.3 T_ADJUSTMENT_MAS is the master table to store the metadata for all the different GAAP Conversion Modules in the system. 1.4 T_ACCOUNT_MAS is the master table for storing all GL Codes in the system. This stores Chart of Accounts (CoA) 1.5 illustrates class component of the conversion system. 1.6 T_USER_MAS is the master table for storing all EGCFC Users. This is the table where the user's username (as appear in Active Directory) is stored so that all authorization and audit logging can be done with reference to the user. 1.7 T_CCE_CATEGORY_MAS is the master table for storing the different CCE categories and parameters used for categorization rules.

2.0 is the batch upload for the input data. 2.1T_CCE_DTLS_ITFC is Temporary Staging/Interface table to store the input data for CCE module, from Excel or Treasury, Intermediate table module and populated by SSIS packages. 2.2 T_CCE_DTLS_ADJ is the main transaction table that stores the details of each instrument.

3.0 Prepare JV option provides the user with an option for preparing the automated JVs based on the business rules incorporated in the system. 3.1 T_CONV_JV_BKNG_HDR_RULE table is used to store the JV headers—narration and the particular JV's mapping to the module. It will have only one line item per JV. 3.2 T_CONV_JV_BKNG_DTL_RULE table is used to store the JV rules for each JV and is a child of the above table. It will have a number of line items per JV and stores the dynamic SQL query for executing the JV logic in this table. 3.3 T_CONV_JV_BKNG_ADJ is the main table where all the JV entries grouped by entity, period, module and version numbers. 3.4 T_CONV_JV_WORKFLOW is the table where JV workflow related active record details are kept. This is joined with the above table on Module, Entity, Period and version to get the latest status of any conversion module. 3.5 T_CONV_JV_COMMENTS is used to store the additional comments of the users on the JVs. 3.6 Submit JV provides an option to the user to submit the JVs for approval.

4.0 is the step for filling the questionnaire. 4.1 T_ACCT_VLDN_STATUS is the table that stores the questionnaire status for each of the conversion module. 4.2 T_ACCT_VLDN_QM_MAP contains the mapping between the conversion modules and questionnaire. 4.3 T_ACCT_VLDN_QA_STATUS table have active and inactive questioner status. 4.4 T_ACCT_VLDN_QA table contains the desired answers of the list of questions maintained in the solution.

5.0 The process for approving journal vouchers provides the approver an option of either approving the JV or rejecting the same by providing the reasons of rejection. 5.1 Post to HFM (a part of the Hyperion™ system) provides an option to the authorized user to post the journal to HFM once the JVs are approved by the approver.

Reports from the Solution

| # | Report Name | Description |
|---|---|---|
| 1. | Reconciliation with Trial | Reconciliation of financial assets classified |
| | Balance Report | as per IFRS with local GAAP trial balance. |
| 2. | Financial Asset | Financial asset based on carrying amount |
| | Classification (based on | classified as per IFRS. |
| | Carrying Amount) Report | |
| 3. | Currency Exposure Analysis | Disclosure of entity's currency exposure to |
| | (based on Fair Value | different classes of financial assets based on |
| | Amount) Report | fair value of the asset. |
| 4. | Currency Exposure Analysis | Disclosure of entity's currency exposure to |
| | (based on Carrying | different classes of financial assets based on |
| | Amount) Report | carrying value of the asset. |
| 5. | Liquidity Analysis (based on | Disclosure of entity's liquidity position of |
| | Carrying Amount) Report | different financial assets based on carrying |
| | | amount of the asset. |
| 6. | Transaction Details Report | Transactional level report of financial |
| | | assets. |
| 7. | Financial Asset | Financial asset based on fair value amount |
| | Classification (based on Fair | classified as per IFRS. |
| | Value Amount) Report | |
| 8. | Liquidity Analysis (based on | Disclosure of entity's liquidity position of |
| | Fair Value Amount) Report | different financial assets based on fair value |
| | | amount of the asset. |

General Ledger (GL) Codes Used for CCE Module

| | Account | Account |
|---|---|---|
| Account Name | Type | Category |
| All the bank accounts | Asset | Balance Sheet |
| All the term deposits related GL codes | Asset | Balance Sheet |
| Income From Mutual Fund | Income | Profit/Loss |
| All the Mutual fund investments GL | Asset | Balance Sheet |
| Codes | | |

FIG. 7 depicts an illustration of Available For Sale (AFS) module of an embodiment of the conversion system as explained herein. Under International reporting standards, investments are classified as Available for sale (AFS), Held Till maturity (HTM) or fair value through profit or loss (FVTPL). Investments made with intent of holding the security till maturity are classified as Held till maturity and are carried at cost. Investments made with intent of sale in near future are classified as Trade securities and are carried at Fair value (FV), any gain loss on FV is routed through Profit & Loss Account i.e. Income Statement. Investments other than HTM and FVTPL are classified as AFS and are carried at FV on the reporting date and any gain/loss on FV is routed through other comprehensive Income, net of deferred tax. In a local GAAP say under Indian GAAP, all investments are carried at cost less of any permanent decline in the value of investment. This module reverses any provision made in local GAAP books for permanent decline in the value of investment and pass conversion journal voucher for the Gain or Loss on fair valuation. Thus, the module caters to the needs of accounting of fair valuation of AFS financial assets and recognition of the difference in fair value, net of deferred tax to Other Comprehensive Income.

The following example would explain the flow of the diagram in a better manner. The example has been solved with the help of the various steps undertaken by the system while executing the program of AFS Module.

A user selects a conversion journal voucher 700 from the available for sale adjustment module 705. At this stage the user is prompted with a query of computing journal voucher 710. If in the selected accounting period, there exists no requirements for passing conversion journal voucher then the module can be skipped after providing valid reasons to approver for approval 715.

If the conversion journal voucher is required, the module will prompt to check if it is a new asset Available for Sale 720. If it is a new AFS asset, the user has to enter the AFS asset details such as entity, period, AFS code (which is a unique code assigned to each asset), AFS share type, AFS share name, No. of shares (Bought), Additions amount/Cost of investment, Base currency, trading partner etc. 725. If it is not a new AFS asset, the user will be asked to identify if it is an addition to existing AFS 730. If yes, the system will fetch the carrying amount from previous period, add the addition amount and enter the fair value of current period 735. Subsequently, an entry will be passed for booking the fair value and impairment loss 755. Further, the system will prompt if any deferred tax is attracted 785. If yes, an entry for deferred tax asset/liability will be passed giving impact on AFS reserve 795. If no, then the deferred tax adjustment will be ignored 790. In both the case a report will be displayed 791 along with submission of responses to questionnaire 793 and the journal voucher is submitted for approval 797.

Similarly, after prompting for new AFS asset, if system concludes that it is not an addition to existing AFS asset, then further it will prompt to check if it is a sale of existing AFS asset 740. If yes, it will ask to enter cost of sales amount, fair value amount of sale 745. If no, it will fetch the carrying amount from previous period and enter fair value for current period 750. Subsequently, profit will be booked in AFS reserve 765. After entering sales amount 745 the amount for provision decline as per LGAAP will be reversed 780 and the profit/loss of LGAAP is also reversed 770. Subsequently step 765 will be followed. After booking profit/loss 765 an entry will be passed to book fair value 760. Further, the system will prompt if any deferred tax is attracted 761. If yes, an entry for deferred tax asset/liability will be passed giving impact on AFS reserve 763. If no, then the deferred tax adjustment will be ignored 766. In both the cases a report will be displayed 767 along with submission of responses to questionnaire 768 and the conversion journal voucher is submitted for approval 769.

Illustration—Company X has an investment portfolio of 100 shares of Company A. The purchase price of these shares is INR 1,000 per share. These shares were fair valued at INR 1,500 per share at the end of previous financial year i.e. 31 Mar. 20XX. On Apr. 3, 20X1, the company purchased additional 100 shares at INR 3,000 per share and sold 50 shares at the selling price of INR 600 per share. The Cost of the shares sold is INR 100,000. At the end of the April 20X1, the fair value of the remaining shares is INR 90,000. There was a provision made in the local books w.r.t the decline in the value of the above shares at INR 10,000. Tax rate assumed to be 30%. Impairment loss is assumed to be nil.

Note 1: An addition of INR 100,000 would be added to the purchase cost of the shares portfolio.

Note 2: The provision amount booked of INR 10,000 would be reversed by way of a Conversion Journal entry. Refer JV No. 1

Note 3: A Conversion Journal entry for reversal of Local GAAP loss on sale of an investment would be passed for INR 70,000 (INR 100,000−INR 30,000). Refer JV No. 4.

Note 4: A Conversion Journal entry for booking of fair valuation gain/loss and booking of loss on redemption/sale of an investment would be passed for INR 330,000 (100,000+300,000−30,000−90,000). Refer JV No. 3.

Note 5: A Conversion Journal entry for booking of deferred tax on fair valuation gain/loss and booking of profit or loss on redemption/sale of an investment would be passed for INR 78,000 (INR 330,000−INR 70,000)@30%. Refer JV No. 6.

Journal Entries Passed for Available for Sale
1. Reversal of the Provision Decline in the value of Investment under LGAAP

| Account Code | Account Description | Dr/Cr | Amount |
|---|---|---|---|
| 18000002 | Provision for Value of | Dr. | 10,000 |
| | Long Term Investments | | |
| 53080024 | Provision for Value of | Cr. | 10,000 |
| | Long Term Investments | | |

2. Fair Valuation of the AFS Investment done every period. Booking of Gain on Fair Valuation

| Account Code | Account Description | Dr/Cr | Amount |
|---|---|---|---|
| 21011802 | Current Investments - Non- | Dr. | — |
| | Trade units in mutual funds | | |
| 21000101 | Long Term Investments Trade - | Dr. | — |
| | Shares quoted | | |
| 10200014 | AFS Reserve | Cr. | — |

3. Fair Valuation of the AFS Investment done every period. Booking of Loss on Fair Valuation

| Account Code | Account Description | Dr/Cr | Amount |
|---|---|---|---|
| 10200014 | AFS Reserve | Dr. | 330,000 |
| 21000101 | Long Term Investments Trade - | Cr. | 330,000 |
| | Shares quoted | | |

4. Redemption of AFS Investments (Reverse accumulated IFRS adjustment)

| Account Code | Account Description | Dr/Cr | Amount |
|---|---|---|---|
| 21000101 | Long Term Investments Trade - | Dr. | 70,000 |
| | Shares quoted | | |
| 10200014 | AFS Reserve | Cr | 70,000 |

5. Booking of impairment of AFS Assets

| Account Code | Account Description | Dr/Cr | Amount |
|---|---|---|---|
| 67010003 | Impairment on AFS | Dr. | — |
| 21000101 | Long Term Investments Trade - | Cr. | — |
| | Shares quoted | | |

6. Deferred Tax on the above fair valuation amount

| Account Code | Account Description | Dr/Cr | Amount |
|---|---|---|---|
| 22000001 | Deferred Tax Asset | Dr. | 78,000 |
| 10200014 | AFS Reserve | Cr | 78,000 |

JV No 1 is passed for reversal of any impairment or provision decline accounted in the LGAAP.

JV No 2 is passed for accounting the fair valuation gain at the end of each reporting period.

JV No 3 is passed for accounting the fair valuation loss at the end of each reporting period.

JV No 4 is passed for reversal of the accumulated IFRS adjustments passed for fair valuation in the previous periods related to the script/instrument sold or redeem during the year.

JV No 5 is passed for accounting the impairment loss on the AFS assets in the international GAAP.

JV No 6 is passed for accounting the deferred tax on the fair valuation carried out during the current period.

E) Reports from the Solution

| # | Report Name | Description |
|---|---|---|
| 1. | Component Level Share | Movement in component level |
| | Type Report | value of investment for a period |
| 2. | Component Level Reserve | Movement in component level AFS |
| | Report | reserve for a period |
| 3. | Share Level Share | Movement in share level value of |
| | Type Report | investment for a period |
| 4. | Share Level Reserve Report | Movement in share level AFS |
| | | reserve for a period |
| 5. | Share Level Reconciliation | Movement in number of shares |
| | Report | during the period. |

1. Component Level Share Type Report

| | | | | | | | | | Inter- |
|---|---|---|---|---|---|---|---|---|---|
| | AFS Share | AFS share | Opening | Addi- | | Movement in | Impair- | | company |
| AFS Code | Type | component | Balance | tions | Disposals | fair Value | ment | Total | Party |
| AFI1001 | MFEQ | XYZ | | | | | | | ICP 1000 |
| AFI1002 | MFEQ | ABC | | | | | | | ICP None |
| AFI1004 | EQ | Company A | 150,000 | 300,000 | (30,000) | (330,000) | — | 90,000 | ICP None |

2. Component Level Reserve Report

| | | | | | | | | Inter |
|---|---|---|---|---|---|---|---|---|
| | AFS Share | AFS share | Opening | Movement due | Movement | Movement due | | Company |
| AFS Code | Type | component | Balance | to fair value | due to sale | to impairment | Total | None |
| AFI1001 | MFEQ | XYZ | | | | | | ICP 1000 |
| AFI1002 | MFEQ | ABC | | | | | | ICP None |
| AFI1004 | EQ | Company A | 50,000 | (330,000) | 70,000 | — | (210,000) | ICP None |
| Total Gross | | | 50,000 | (330,000) | 70,000 | — | (210,000) | |
| Tax impact | | | (15,000) | 99,000 | (21,000) | — | 63,000 | |
| Total Net | | | 35,000 | (231,000) | 49,000 | — | (147,000) | |

3. Share Level Share Type Report

| | | | | | | | Inter- |
|---|---|---|---|---|---|---|---|
| AFS Share | Opening | | | Movement in | Impair- | | company |
| Type | Balance | Additions | Disposals | fair Value | ment | Total | Party |
| MFEQ | — | — | — | — | — | — | ICP 1000 |
| EQ | 150,000 | 300,000 | (30,000) | (330,000) | — | 90,000 | ICP None |

4. Share Level Reserve Report

| | | | | | | Inter |
|---|---|---|---|---|---|---|
| AFS Share | Opening | Movement due | Movement | Movement due | | Company |
| Type | Balance | to fair value | due to sale | to impairment | Total | Party |
| MFEQ | — | — | — | — | — | |
| EQ | 50,000 | (330,000) | 70,000 | — | (210,000) | ICP None |
| Total Gross | 50,000 | (330,000) | 70,000 | — | (210,000) | |
| Tax impact | (15,000) | 99,000 | (21,000) | — | 63,000 | |
| Total Net | 35,000 | (231,000) | 49,000 | — | (147,000) | |

Numbers in bracket represent deferred tax liability amount.

5. Share Level Reconciliation Report

| Share | Opening Outstanding | Additions | Sale Of | Closing No. |
|---|---|---|---|---|
| Type | No. Of Shares | Of Shares | Shares | Of Shares |
| MFEQ | — | — | — | — |
| EQ | 100 | 100 | (50) | 150 |
| Total | 100 | 100 | (50) | 150 |

F) General Ledger Codes Used for AFS Module

| Account | | Account | Account |
|---|---|---|---|
| Code | Account Name | Type | Category |
| 53080024 | PROVISION FOR VALUE OF | Expense | Profit |
| | LONG TERM INVESTMENTS | | and Loss |
| 20840001 | PRE - OPERATIVE EXPENSES - | Asset | Balance |
| | ALLOCABLE | | Sheet |
| 21000101 | LTI TRADE SHARES QUOTED | Asset | Balance |
| | | | Sheet |
| 21000401 | LTI TRADE SHARES UNQUOTED | Asset | Balance |
| | | | Sheet |
| 21001001 | LTI NON - TRADE SHARES | Asset | Balance |
| | QUOTED - GOV/TRUST SEC | | Sheet |
| 21001002 | LTI NON - TRADE SHARES | Asset | Balance |
| | UNQUOTED - GOV/TRUST SEC | | Sheet |
| 21001101 | LTI NON - TRADE SHARES | Asset | Balance |
| | QUOTED | | Sheet |
| 21001201 | LTI NON - TRADE DEBENTURE | Asset | Balance |
| | QUOTED | | Sheet |
| 21001401 | LTI NON - TRADE SHARES | Asset | Balance |
| | UNQUOTED | | Sheet |
| 21001501 | LTI NON - TRADE DEBENTURE | Asset | Balance |
| | UNQUOTED | | Sheet |
| 21002301 | LONG TERM INVESTMENTS - | Asset | Balance |
| | SUBSIDIARIES UNQUOTED | | Sheet |
| 21010101 | CI TRADE SHARES QUOTED | Asset | Balance |
| | | | Sheet |
| 21010401 | CI TRADE SHARES UNQUOTED | Asset | Balance |
| | | | Sheet |
| 21011801 | CI NON - TRADE UNITS IN | Asset | Balance |
| | MUTUAL FUNDS UNQUOTED | | Sheet |
| 18000003 | PROVISION FOR VALUE OF | Liability | Balance |
| | CURRENT INVESTMENTS [B/S] | | Sheet |
| 18000004 | PROVISION FOR OBSOLETE/ | Liability | Balance |
| | SLOW MOVING STOCK [B/S] | | Sheet |
| 10200014 | AFS Reserve | Liability | Balance |
| | | | Sheet |
| 67010003 | Impairment on AFS | Expense | Profit |
| | | | and Loss |

The present invention has been converted into computerized flexible systems and methods in such a manner that it can be enhanced and modified to deal with and take care of new accounting standards and/or changes in existing accounting standards in local GAAP like in India, USA or international GAAP like IFRS.

While particular embodiments of the present invention have been described and illustrated, it should be understood that the invention is not limited thereto because modifications may be made by persons skilled in the art. The present application contemplates any and all modifications that fall within the spirit and scope of the underlying invention disclosed and claimed herein.

We claim:

1. A system for converting and presenting financial information from at least one accounting and reporting standard to another accounting and reporting standard comprising:
a. an access control means to verify credentials of a user logging-in to get access of the system;
b. an input source for maintaining books of accounts and generating account head-wise trial balance;
c. an extraction layer for fetching the account head-wise trial balance from the input sources;
d. a financial data management module (FDM) for validating and mapping account head-wise trial balance received from the input sources;
e. an ETL block to fetch account head-wise trial balance from the FDM and other transaction details from an interface table and populate the same in the form of a financial information into a database for storage;
f. the database capable of storing financial information received from the ETL block and also converted financial information from one accounting and reporting standard to another accounting and reporting standards;
g. a processing block including a data access block, a validation block, a business logic block, a presentation block and a security block;
h. the data access block capable of extracting, editing and mapping the financial information from the database;
i. the validation block capable of validating financial information received from the data access block based on predefined logic, rules and calculations;
the business logic block capable of converting financial information from one accounting and reporting standard to another accounting and reporting standard based on predefined rules, calculations, and logics;
k. the presentation block capable of presenting the converted financial information based on user specific requirements;
l. the security block capable of protecting financial information through access control and various information security measures.

2. A system for converting and presenting financial information as claimed in claim 1, wherein the access control means includes physical access control, biometric access control, retina access control, fingerprints access control and the like.

3. A system for converting and presenting financial information as claimed in claim 1, wherein the books of accounts are in the form of day to day transactions pertaining to capital expenditure, administrative expenditure, revenue, investments, bills payable, bills receivable, details of debtor and creditor, fixed and liquid assets including cash, short and long term liability including loan and the like.

4. A system for converting and presenting financial information as claimed in claim 1, wherein said accounting and reporting standard corresponds to a country specific Generally Accepted Accounting Principles (GAAP) such as Indian GAAP, US GAAP, Canadian GAAP, Indonesian GAAP, Japanese GAAP, International Financial Reporting Standards and the like.

5. A system for converting and presenting financial information as claimed in claim 1, wherein the input sources are any systems for writing books of accounts and capable of calculating account head-wise trial balance.

6. A system for converting and presenting financial information as claimed in claim 5, wherein the systems for writing books of accounts are pre-formatted Microsoft Excel files, or any other enterprise resource planning system such as SAP™, Tally™ and the like.

7. A system for converting and presenting financial information as claimed in claim 1, wherein the extraction layer is a pre-codified program capable of fetching the account head-wise trial balance from the input sources and converting the same into the FDM complaint format.

8. A system for converting and presenting financial information as claimed in claim 1, wherein the financial data management module is capable of validating and mapping account head-wise trial balance into country specific regulatory compliant account head-wise trial balance using best financial practices.

9. A system for converting financial information as claimed in claim 1, wherein the ETL block is a pre-programmed block capable of extracting and receiving account head-wise trial balance and other transaction details and populating the same into the database.

10. A system for converting financial information as claimed in claim 1, wherein the interface table is designed and created considering various conversion requirements from one accounting and reporting standard to other and vice versa.

11. A system for converting financial information as claimed in claim 1, wherein the database is a relational database management system in which the data is stored and manipulated collectively with various queries in a query language.

12. A system for converting financial information as claimed in claim 1, wherein the data access block is a pre-programmed block containing a predefined logic to modify and add financial information, map and store into the database and extract the same from the database and populates the same into the validation block.

13. A system for converting financial information as claimed in claim 1, wherein the validation block contains predefined logic to validate the financial information.

14. A system for converting financial information as claimed in claim 1, wherein the processing block executes all functionalities and processing actions required to convert the financial information from one accounting and reporting standard to another accounting and reporting standard.

15. A system for converting financial information as claimed in claim 1, wherein the business logic block converts the conversion compliant financial information using predefined set of rules, calculations and logic.

16. A system for converting financial information as claimed in claim 1, wherein the presentation block is any graphical user interface presenting the information with control features for user to view and print financial information before and after conversion.

17. A system for converting financial information as claimed in claim 1, wherein the security block includes access control, data security and information security measure using pre-codified rules.

18. A method for converting and presenting financial information from at least one accounting and reporting standard to another accounting and reporting standard comprising:
a. receiving, ascertaining and validating access request from the user for maintaining books of accounts;
b. feeding accounting including journal entries into the input sources through various primary books of accounts;
c. editing, and converting accounting including journal entries into account head specific trial balance using predefined logic and populating the same into the financial data management module;
d. validating and mapping the account head specific trial balance into the financial data management module based on predefined rules;
e. pulling the validated and mapped account head specific trial balance from the financial data management module and other transactions details from an interface table through extract transform and load block, and pushing the same into a database in the form of financial information;
f. connecting, extracting the financial information from the database using a data access block and also allowing the user to modify and map the financial information under various modules, if required, after ascertaining the user's credentials through a security block;
g. validating the extracted financial information from the database using the data access block through a validation block capable of validating the financial information on various parameters such as type of the financial information, mapping of the financial information, user access related validation, format of the financial information, and the like and pushing the same into a business logic block;
h. converting the financial information from one accounting and reporting standard to other using various pre-codified business rules present in the business logic block;
i. generating user specific and module specific report using the business logic block;
j. presenting the converted financial information from one accounting and reporting standard to other using presentation block.

19. A method as claimed in claim 18, further comprises upon ascertaining an unauthorized access request, denying the access to the user.

20. A method as claimed in claim 19, wherein the access request includes username, password, encrypted data log-in or any access control means, and the like.

21. A method as claimed in claim 18, wherein the books of accounts are in the form of day to day transactions pertaining to capital expenditure, administrative expenditure, revenue, investments, bills payable, bills receivable, details of debtor and creditor, fixed and liquid assets including cash, short and long term liability including loan and the like.

22. A method as claimed in claim 18, wherein the input sources are any systems for writing books of accounts.

23. A method as claimed in claim 22, wherein the system for writing books of accounts are pre-formatted Microsoft™ Excel™ files, or any other enterprise resource planning system such as SAP™, Tally™ and the like.

24. A method as claimed in claim 18, wherein the primary books of accounts are cash books, bank book, purchase and sales ledgers, general ledgers and the like.

25. A method as claimed in claim 18, wherein said accounting and reporting standard corresponds to a country specific Generally Accepted Accounting Principles (GAAP) such as Indian GAAP, US GAAP, Canadian GAAP, Indonesian GAAP, Japanese GAAP, International Financial Reporting Standards and the like.

26. A method as claimed in claim 18, wherein the financial data management module is capable of validating and mapping financial information into country specific regulatory compliant financial information using best financial practices.

27. A method as claimed in claim 18, wherein the data access block is capable of connecting and extracting financial information using various object and helper classes and also contains various pre-codified logics to verify user's credentials and allows the user to modify, update, alter, upload the financial information.

28. A method as claimed in claim 18, where the various types of modules are Administration and Overhead Capital Work in Progress, Available For Sale, Bill Discounting (Debtors), Bills Payable (Acceptances), Borrowings, Cash And Cash Equivalent, Construction, Current/Non Current Reclassification, Decapitalization of Forex, Deferred Tax, Derivatives, Employee Benefits, Financial Guarantee, Forward Cover/Contract, Held For Sale, Intangible Assets, Inventory, Investment Property, Leases, Loans, Manual Journal Vouchers, Outsourced Costs, Personnel Costs, Preference Shares-Liability, Property, Plant And Equipment, Provisions, Sales Tax, Scrap Sales, and the like.

29. A method as claimed in claim 18, wherein the security block is a multi-tier security layer which is capable of defining the access rights for a user at either an application, task or object level.

30. A method as claimed in claim 18, the business logic block is capable of converting financial information from one accounting and reporting standard to another using certain predefined and pre-programmed business rules such as pre-identified points of differences between the accounting and reporting standard under which the financial information is fed vis-à-vis the accounting and reporting standard in which the financial information is to be converted, comparing financial information present in master data before and after conversion, applying points of differences on the data fed in and converting the financial information and generate required output in the form of a report.

31. A method as claimed in claim 18, the business block is also capable of generating user and module specific reports including time taken by user to enter details in a specific module, time taken by the module to convert the financial information using business logic block, user-wise time log, module-wise time log and the like.

32. A method as claimed in claim 18, the presentation block is capable of presenting the converted financial information based on user specific queries using various user interface such as web based screens, controls, workflow guidance, navigation and the like.
